(19) United States
(12) Patent Application Publication
(10) Pub. No.: US 2026/0209060 A1
(43) Pub. Date: Jul. 23, 2026

(54) METHODS FOR PREPARING FLY ASH-BASED LAYERED DOUBLE HYDROXIDES MODIFIED BY MOLYBDENUM SULFIDE INTERCALATION

(71) Applicant: ZHEJIANG UNIVERSITY, Hangzhou (CN)

(72) Inventors: Yaqi PENG, Hangzhou (CN); Weichao KONG, Hangzhou (CN); Shengyong LU, Hangzhou (CN); Jiamin DING, Hangzhou (CN); Hengsheng PAN, Hangzhou (CN); Xin XIAO, Hangzhou (CN); Jianhua YAN, Hangzhou (CN)

(73) Assignee: ZHEJIANG UNIVERSITY, Hangzhou (CN)

(21) Appl. No.: 19/453,102

(22) Filed: Jan. 20, 2026

(30) Foreign Application Priority Data
Jan. 20, 2025 (CN) 202510087284.0

(51) Int. Cl. C01F 7/784

(52) U.S. Cl. CPC C01F 7/784; C01P 2002/08; C01P 2002/22; C01P 2004/03

(57) ABSTRACT

Provided is a method for preparing fly ash-based layered double hydroxides (LDHs) modified by molybdenum sulfide intercalation. The fly ash-based LDHs are prepared by mixing washed fly ash with AlCl₃ and hydrochloric acid and adjusting pH by using NaOH. On this basis, a single-phase material, molybdenum sulfide intercalation-modified fly ash-based LDHs, is prepared by coupling MoS₄²⁻ via a mechanochemical process. The process can not only significantly improve the adsorption capacity of the fly ash-derived LDHs for heavy metal ions including Pb²⁺, Ag⁺, Hg²⁺, and Cu²⁺, but also endow the LDHs with heavy metal adsorption selectivity, with the following order: Ag⁺>Hg²⁺>Cu²⁺>Pb²⁺>others. In addition, the mechanochemical process can remarkably reduce Mo leaching, thereby lowering material hazard while also reducing cost, energy consumption, and environmental impact.

### CROSS-REFERENCE TO RELATED APPLICATIONS

This application claims priority to the Chinese Patent Application No. 202510087284.0, filed on Jan. 20, 2025, the contents of which are hereby incorporated by reference.

### TECHNICAL FIELD

The present disclosure generally relates to a field of environmental protection technology, and in particular to a method for preparing fly ash-based layered double hydroxides (LDHs) modified by molybdenum sulfide intercalation.

### BACKGROUND

With the rapid development of the city economy and the enhancement of public environmental awareness, the generation of municipal solid waste and the proportion of incineration treatment have been continuously rising. This change has also led to an increase in the production of fly ash from municipal solid waste incineration, making the treatment and resource utilization of the fly ash an important problem that needs to be solved urgently. Currently, the fly ash from municipal solid waste incineration is mainly treated by landfill and co-processing in cement kilns. However, with the continuous improvement of government policies, it is particularly crucial to enhance the treatment and resource utilization capacity of the fly ash. Traditional methods have become difficult to meet demands due to environmental risks and treatment capacity limitations. Therefore, there is a need to develop more high-value-added, low-cost green resource recovery technologies to effectively treat the fly ash from municipal solid waste incineration. LDHs is anionic clay materials composed of a main layer structure, interlayer anions, and water molecules. The most common synthesis method is the combination of co-precipitation method and hydrothermal method. Currently, LDHs are mainly investigated for applications in catalysts, adsorbents, flame retardants, corrosion inhibitors, etc.

Preparation of the LDHs using the fly ash as raw material is a green resource utilization technology with high added value and low cost that can meet the requirements. Currently, the LDHs have been applied in heavy metal adsorption to a certain extent, and the fly ash-derived LDHs have adsorption capability not significantly different from commercially available LDHs. However, when the selective adsorption of a single heavy metal is required, the fly ash-derived LDHs lack selectivity. Based on this, there is an urgent need in the market to provide a modified fly ash-based LDHs with selective adsorption for the heavy metals.

### SUMMARY

One or more embodiments of the present disclosure provide a method for preparing fly ash-based LDHs modified by molybdenum sulfide intercalation. The method includes the following operations: S1, washing fly ash from municipal solid waste incineration 1 to 2 times by adding the fly ash into a sodium hydroxide solution, wherein a liquid-to-solid ratio of the sodium hydroxide solution to the fly ash is (10-12) mL:1 g; and taking solids after filtration to obtain washed fly ash solids; S2, mixing the washed fly ash solids, deionized water, a hydrochloric acid solution, and aluminum chloride, wherein a mass ratio of the washed fly ash solids to the aluminum chloride is (5-20):1, and the deionized water is added according to the liquid-to-solid ratio of (10-14) mL:1 g; adjusting a pH to 11-13 by using sodium hydroxide, fully stirring to obtain a mixture, transferring the mixture into a ball mill jar for temperature-controlled ball milling, and performing centrifugation, water washing, and drying on a solid-liquid mixture obtained after the ball milling to obtain the fly ash-based LDH; S3, adding ammonium tetrathiomolybdate into the fly ash-based LDH obtained in S2, wherein the mass ratio of the fly ash-based LDH to the ammonium tetrathiomolybdate is (1.1-1.5):1, adding the deionized water, and performing the temperature-controlled ball milling to obtain a mixed solution; and S4, performing centrifugation, filtration, washing, and drying on the mixed solution obtained in S3 to obtain a molybdenum sulfide intercalation-modified fly ash-based LDH; wherein in S2, a rotational speed of the ball mill jar is 700-900 rpm, a ball-to-material ratio is (4-7):1, a ball-milling time is 4-6 h, and a ball-milling temperature is controlled at 100-120° C.; and in S3, conditions for the temperature-controlled ball milling include the ball-to-material ratio of (8-10):1, a ball-milling time of 6-8 h, a rotation speed of 400-500 rpm, and a ball-milling temperature controlled at 80-100° C.

In some embodiments, in S1, a concentration of the sodium hydroxide solution is 0.5-1 mol/L.

In some embodiments, in S1, a process of the washing includes: fully shaking for 6-8 h and standing for 22-24 h.

In some embodiments, in S1, a process of the washing includes: stirring for 6 h, and standing for 24 h.

In some embodiments, in S1, the filtration is vacuum filtration using a filter membrane with a pore size of 0.45 μm.

In some embodiments, in S2, a concentration of the hydrochloric acid solution is 1-1.2 mol/L.

In some embodiments, in S2, the mass ratio of the washed fly ash solids to the aluminum chloride is 10:1.

In some embodiments, in S2, the rotational speed of the ball mill jar is 900 rpm, the ball-milling temperature is 110° C., and the ball-milling time is 6 h.

In some embodiments, in S3, a liquid-to-solid ratio of the deionized water to a mixture of the fly ash-based LDH and the ammonium tetrathiomolybdate is (8-12) mL:1 g.

In some embodiments, in S3, the ball-to-material ratio is 10:1, the rotation speed is 400 rpm, the ball-milling time is 6 h, and the ball-milling temperature is 80° C.

In some embodiments, in S4, a process of the washing includes washing with water twice and washing with ethanol once.

In some embodiments, in S4, the drying is performed at 80-105° C. in a nitrogen atmosphere.

In some embodiments, in S4, the drying is performed at 100° C. in the nitrogen atmosphere for 12 h.

One or more embodiments of the present disclosure also provide a molybdenum sulfide intercalation-modified fly ash-based LDH, which is prepared by using the method for preparing fly ash-based LDHs modified by molybdenum sulfide intercalation.

### BRIEF DESCRIPTION OF THE DRAWINGS

FIG. 1 a flowchart illustrating an exemplary process of a method for preparing fly ash-based LDHs modified by molybdenum sulfide intercalation.

FIG. 2 is a scanning electron microscope (SEM) image of LDHs obtained in example 1 of the present disclosure.

### DETAILED DESCRIPTION

The following embodiments are provided herein for illustrating preferred embodiments of the present disclosure. Those skilled in the art will understand that the technologies disclosed in the following embodiments represent technologies that the inventors have found to be useful for implementing the present disclosure, and therefore may be considered as preferred schemes for implementing the present disclosure. However, those skilled in the art will understand from the present disclosure that many modifications may be made to the specific embodiments disclosed herein while still achieving the same or similar results, without departing from the spirit or scope of the present disclosure.

Unless otherwise defined, all technical and scientific terms used herein have the same meanings as commonly understood by one of ordinary skill in the art to which the present disclosure belongs. The materials disclosed herein and the materials cited by the materials disclosed herein are incorporated herein by reference. Those skilled in the art will recognize or will be able to ascertain using no more than routine experimentation, many equivalents to the specific embodiments of the present disclosure described herein. These equivalents are intended to be encompassed by the claims.

The technical solutions of the present disclosure are described in further detail below in conjunction with specific embodiments.

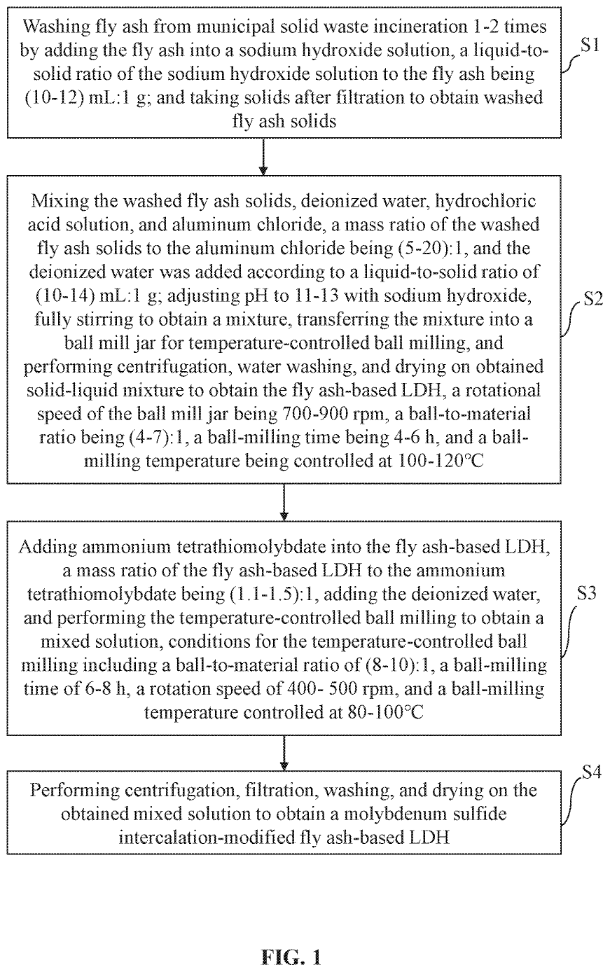

FIG. 1 is a flowchart illustrating an exemplary process of a method for preparing fly ash-based LDHs modified by molybdenum sulfide intercalation.

The fly ash-based LDHs modified by molybdenum sulfide intercalation (or referred to as molybdenum sulfide intercalation-modified fly ash-based LDH) refer to a modified material prepared by utilizing the fly ash from municipal solid waste incineration as raw material, first converting the fly ash into a Cl⁻-containing Ca—Al LDH, and then introducing MoS₄²⁻ into the interlayer via intercalation reaction through resourcefully utilization of the effective components of the fly ash. The molybdenum sulfide intercalation-modified fly ash-based LDH is denoted as CaAl—MoS₄-LDH.

Given variations in the fly ash composition derived from different sources and incineration processes, the fly ash used in the present disclosure is typical fly ash from municipal solid waste incineration, whose typical chemical composition generally includes CaO (30%-50%), Al₂O₃ (5%-15%), SiO₂ (10%-20%), as well as a certain content of chlorides and the heavy metals. In some embodiments, the abundant calcium-based components (such as CaO, Ca(OH)₂, or CaCl₂) in the fly ash are utilized as an in-situ calcium source for preparing Ca—Al type LDH. By adding an aluminum salt (such as aluminum chloride) and adjusting the pH, the soluble calcium in the fly ash synergistically precipitates with the externally added aluminum components to construct a layered structure. Experimental data show that as long as the fly ash contains a certain proportion of soluble calcium components, stable synthesis of the LDH structure can be achieved through specific leaching, washing, and reaction conditions in the present disclosure.

The fly ash-based LDH refers to LDH prepared by a chemical reaction using the fly ash from municipal solid waste incineration as the raw material. The LDH refers to a material composed of positively charged hydroxide layers, the interlayer anions, and the water molecules. In some embodiments, calcium (Ca) and aluminum (Al) contained in the fly ash may serve as divalent metal cation and trivalent metal cation, and chloride ions (Cl⁻) may serve as the interlayer anions, to form the chloride intercalated fly ash-based LDH, denoted as CaAl—Cl-LDH.

As shown in FIG. 1, the method includes the following operations S1-S4.
In S1, washing fly ash from municipal solid waste incineration 1 to 2 times by adding the fly ash into a sodium hydroxide solution, a liquid-to-solid ratio of the sodium hydroxide solution to the fly ash being (10-12) mL:1 g; and taking solids after filtration to obtain washed fly ash solids.

The fly ash refers to solid residues produced by incinerating municipal solid waste or other solid waste in an incinerator. The fly ash usually contains a plurality of metal oxides, chlorides, unburned carbon, and other substances.

The washed fly ash solids refer to a solid product obtained by adding the fly ash from municipal solid waste incineration to the sodium hydroxide solution, fully shaking and standing soaking according to the liquid-to-solid ratio of (10-12) mL:1 g, and then performing solid-liquid separation.

The washing refers to a process in which the fly ash from municipal solid waste incineration is fully contacted with the sodium hydroxide solution to remove impurities from the fly ash or extract desired components through physical action or chemical action. The process usually includes mixing, stirring or shaking, and subsequent filtration operations.

In some embodiments, the washing may be performed in a plurality of ways, for example, stirring washing, ultrasonic washing, or shaking washing.

In some embodiments, in S1, a concentration of the sodium hydroxide solution is 0.5-1 mol/L.

The sodium hydroxide solution is used for washing treatment of the fly ash from municipal solid waste incineration. In some embodiments, in S1, the concentration of the sodium hydroxide solution may be 0.5 mol/L, 0.6 mol/L, 0.7 mol/L, 0.8 mol/L, 0.9 mol/L, or 1 mol/L. In some embodiments, in S1, the concentration of the sodium hydroxide solution may also be 0.55 mol/L, 0.75 mol/L, or 0.95 mol/L. In some embodiments, in S1, the concentration of the sodium hydroxide solution may be 0.5-0.55 mol/L, 0.5-0.6 mol/L, 0.5-0.7 mol/L, 0.5-0.8 mol/L, 0.5-0.9 mol/L, or 0.95-1 mol/L. In some embodiments, in S1, the concentration of the sodium hydroxide solution may also be adjusted according to specific components of the fly ash and performance requirements of a target product, so that the concentration remains within a range capable of effectively pretreating the fly ash.

By controlling the concentration of the sodium hydroxide solution in S1 to 0.5-1 mol/L, it can ensure sufficient and effective pretreatment of the fly ash from municipal solid waste incineration. The pretreatment helps remove interfering impurities from the fly ash and optimizes surface properties of the fly ash, thereby promoting smooth formation and structural optimization of the fly ash-based LDH in S2.

In some embodiments, in S1, a process of the washing includes fully shaking for 6-8 h and standing for 22-24 h.

The fully shaking refers to a process of performing violent and continuous shaking on a mixture of the fly ash and the sodium hydroxide solution by a mechanical vibration device or other means during the washing process to ensure maximum contact and mass transfer efficiency between the solid and the liquid. For example, a horizontal shaker, a rotary shaker, or a stirrer with a vibration function may be employed to achieve the fully shaking.

In some embodiments, the fully shaking may be achieved by means other than the above-mentioned means, for example, by ultrasonic shaking, or by a magnetic stirrer with a vibration function.

In some embodiments, a duration of the fully shaking may be 6 h, 7 h, or 8 h. As another example, the duration of the fully shaking may be 6.5 h, 7.2 h, or 7.8 h, etc. In some embodiments, the duration of the fully shaking may be 6-6.5 h, 6.5-7 h, or 7-8 h, etc. In some embodiments, the duration of the fully shaking may also be adjusted according to actual processing volume and features of the fly ash, for example, the fully shaking may be performed for 5 h or 9 h.

In some embodiments, in S1, a shaking frequency of the fully shaking is 150-250 rpm. For example, in the operation of example 1, the shaking frequency may be set to 200 rpm, and continuous shaking may be performed for 6 h to ensure uniform mixing of the solid phase and the liquid phase, providing a uniform raw material basis for subsequent synthesis of structurally stable CaAl—Cl-LDH.

In some embodiments, a duration of the standing may be 22 h, 23 h, or 24 h. As another example, the duration of the standing may be 22.5 h, 23.3 h, or 23.9 h. In some embodiments, the duration of the standing may be 22-22.5 h, 22.5-23 h, 23-23.5 h, or 23-24 h. In some embodiments, the duration of the standing may also be adjusted according to actual sedimentation speed and required separation effect, for example, the standing may be performed for 20 h or 25 h.

In some embodiments, in S1, a process of the washing includes: stirring for 6 h and standing for 24 h.

For example, the mechanical stirrer, the magnetic stirrer, or the paddle stirrer may be employed for the stirring.

By the fully shaking for 6-8 h and the standing for 22-24 h (e.g., the stirring for 6 h and the standing for 24 h) in the washing step, a full contact between the fly ash from municipal solid waste incineration and the sodium hydroxide solution can be ensured, thereby effectively removing harmful impurities and interfering components, such as chloride ions and heavy metal ions, from the fly ash. The full shaking helps to improve washing efficiency and leaching rate. The sufficiently long-standing duration facilitates full settling of solid particles, thereby obtaining purer washed fly ash solids, providing high-quality raw material for subsequent preparation of the fly ash-based LDH, thereby improving purity and adsorption performance of a final product.

In some embodiments, in S1, a liquid-to-solid ratio of the sodium hydroxide solution to the fly ash is (10-12) mL:1 g. In some embodiments, in S1, the liquid-to-solid ratio of the sodium hydroxide solution to the fly ash is (10-10.5) mL:1 g, (10.5-11) mL:1 g, (11-11.5) mL:1 g, or (11.5-12) mL:1 g. For example, the liquid-to-solid ratio may be 10 mL:1 g, 11 mL:1 g, 11.5 mL:1 g, or 12 mL:1 g.

In some embodiments, the filtration may be the vacuum filtration, pressure filtration, gravity filtration, or the like. In some embodiments, the filtration may also be performed by centrifugation, sedimentation, or the like.

In some embodiments, a pore size of a filter membrane for the vacuum filtration may be 0.2-0.25 μm, 0.25-0.3 μm, 0.3-0.35 μm, 0.35-0.4 μm, 0.4-0.45 μm, 0.45-0.55 μm, 0.55-0.6 μm, or 0.6-0.8 μm. For example, the filter membrane with the pore size of 0.2 μm may be employed to achieve finer retention of solid particles. Alternatively, the filter membrane with the pore size of 0.8 μm may be employed to increase filtration speed while ensuring the certain separation effect.

In some embodiments, in S1, the filtration is the vacuum filtration using the filter membrane with the pore size of 0.45 μm.

In some embodiments, when performing solid-liquid separation on the mixture of the washed fly ash and the sodium hydroxide solution in S1, the vacuum filtration may be specifically performed using the filter membrane with the pore size of 0.45 μm. For example, the mixture may be introduced into a Buchner funnel or a sintered glass funnel equipped with the 0.45 μm filter membrane, and a negative pressure is generated below the filter membrane by connecting a device such as a vacuum pump or a hydraulic pump, thereby driving the liquid to rapidly pass through the filter membrane and efficiently retaining the washed fly ash solids on the filter membrane surface, which can ensure that the fly ash solids used in subsequent operations have high purity and uniformity.

The vacuum filtration is performed by using the filter membrane with the pore size of 0.45 μm, which can efficiently and thoroughly separate the washed fly ash solids from municipal solid waste incineration by the sodium hydroxide solution from impurities and unreacted components in the solution. This facilitates the acquisition of pure washed fly ash solids, providing the high-quality material for subsequent preparing fly ash-based LDH, thereby enhancing the performance and purity of the final product. Meanwhile, the vacuum filtration can accelerate the speed of the solid-liquid separation and improve efficiency of the entire preparation process.
In S2, mixing the washed fly ash solids, deionized water, a hydrochloric acid solution, and aluminum chloride, a mass ratio of the washed fly ash solids to the aluminum chloride being (5-20):1, and the deionized water being added according to a liquid-to-solid ratio of (10-14) mL:1 g; adjusting a pH to 11-13 with sodium hydroxide, fully stirring to obtain a mixture, transferring the mixture into a ball mill jar for temperature-controlled ball milling, and performing centrifugation, water washing, and drying on a solid-liquid mixture obtained after the ball milling to obtain the fly ash-based LDH, a rotational speed of the ball mill jar being 700-900 rpm, a ball-to-material ratio being (4-7):1, a ball-milling time being 4-6 h, and a ball-milling temperature being controlled at 100-120° C.

In some embodiments, in S2, the concentration of the hydrochloric acid solution is 1-1.2 mol/L.

In some embodiments, the concentration of the hydrochloric acid solution may be 1 mol/L. For example, the hydrochloric acid solution with the concentration of 1 mol/L may be mixed with the washed fly ash solids, the deionized water, and the aluminum chloride. In some embodiments, the concentration of the hydrochloric acid solution may also be 1.2 mol/L. In some embodiments, the concentration of the hydrochloric acid solution may also be 1-1.02 mol/L, 1.02-1.06 mol/L, 1.06-1.1 mol/L, 1.1-1.15 mol/L, or 1.15-1.2 mol/L. For example, according to specific reaction requirements, a suitable concentration of the hydrochloric acid solution may be selected or prepared within the range of 1-1.2 mol/L. In some embodiments, the concentration of the hydrochloric acid solution may be any value within the above range. For example, the concentration of the hydrochloric acid solution may be 1.0 mol/L, 1.02 mol/L, 1.08 mol/L, 1.12 mol/L, 1.18 mol/L, or 1.2 mol/L.

In some embodiments, an added amount of the hydrochloric acid solution may be controlled based on a mass of the washed fly ash solids. In some embodiments, the liquid-to-solid ratio of the hydrochloric acid solution to the washed fly ash solids may be set to (2-4) mL:1 g. For example, the liquid-to-solid ratio of the hydrochloric acid solution to the washed fly ash solids may be 2.5 mL/g, 3 mL/g, or 3.5 mL/g.

By controlling the concentration of the hydrochloric acid solution, the formation of the fly ash-based LDH is facilitated, ensuring that the mixture possesses appropriate acidity. This facilitates the dissolution of effective components from the fly ash and promotes the formation of stable LDH structures during subsequent pH adjustment and ball milling processes. It can optimize synthesis and structure of LDHs, yielding LDHs with favorable interlayer spacing and crystal integrity, enable effective formation of the molybdenum sulfide intercalation-modified fly ash-based LDH, significantly enhancing the adsorption capacity and ability of the final product for the heavy metal ions.

The washed fly ash solids refer to a solid product obtained after treatment in S1. The solid product is obtained by washing the fly ash from municipal solid waste incineration with the sodium hydroxide (NaOH) solution and performing solid-liquid separation, which serves as the raw material for preparing the fly ash-based LDHs. In some embodiments of the present disclosure, aluminum chloride (AlCl₃) serves as an aluminum (Al) source and participates in a formation reaction of the fly ash-based LDHs in S2.

A mass ratio of the washed fly ash solids to the aluminum chloride is one of parameters affecting formation efficiency and product performance of the fly ash-based LDHs. In some embodiments, the mass ratio of the washed fly ash solids to the aluminum chloride may be selected within a range of (5:1)-(20:1). In some embodiments, the mass ratio of the washed fly ash solids to the aluminum chloride may be (5-7):1, (5-9):1, (5-11):1, (5-12):1, (5-14):1, (5-16):1, (5-18):1, or (18-20):1. For example, the mass ratio of the washed fly ash solids to the aluminum chloride may be 5:1, 6:1, 8:1, 12:1, 15:1, 18:1, or 20:1. In some embodiments, the mass ratio of the washed fly ash solids to the aluminum chloride may also be determined in other ways. For example, the optimal mass ratio of the washed fly ash solids to the aluminum chloride may be determined by conducting preliminary experiments to investigate effects of different mass ratios on yield, crystal structure, and heavy metal adsorption performance of LDHs.

In some embodiments, in S2, the mass ratio of the washed fly ash solids to the aluminum chloride is 10:1.

By controlling the mass ratio of the fly ash-based layered double hydroxide to the aluminum chloride at 10:1, the synthesis and structure of the fly ash-based LDHs can be optimized. It also enhances material stability and reduces the risk of molybdenum (Mo) leaching, thereby minimizing potential hazards during application, and contributes to lowering production costs and energy consumption.

In some embodiments, in S2, the deionized water is added according to the liquid-to-solid ratio of (10-14) mL:1 g. For example, the liquid-to-solid ratio of the deionized water to the mixture may be 11 mL:1 g. As another example, the liquid-to-solid ratio of the deionized water to the mixture may be 12 mL:1 g. In some other embodiments, the liquid-to-solid ratio of the deionized water to the mixture may be (10-11) mL:1 g, (11-12) mL:1 g, (12-13) mL:1 g, or (13-14) mL:1 g.

In some embodiments, after mixing, the pH of the mixture is adjusted to 11-13 using the sodium hydroxide solution. For example, the pH of the mixture may be adjusted to 11, 12, or 13. The pH adjustment refers to an operation of changing acidity or alkalinity of a solution by adding an acidic or alkaline substance to achieve a target pH. In S2, the sodium hydroxide solution is used as an alkaline substance to increase the pH of the mixture. In some embodiments, other alkaline substances may also be used for the pH adjustment, such as a potassium hydroxide solution or ammonia water.

In some embodiments, after adjusting the pH, the mixture is fully stirred. Then, the mixture is transferred to the ball mill jar for the temperature-controlled ball milling. After the ball milling is completed, centrifugation, water washing, and drying are performed on the obtained solid-liquid mixture to obtain the fly ash-based LDH.

In some embodiments of the present disclosure, the fully stirring refers to stirring with sufficient intensity and time to ensure that reactants are fully mixed, and the pH adjustment process reaches equilibrium, thereby providing a uniform precursor environment for subsequent ball milling synthesis of the LDH structure.

For example, at room temperature, the mixture is continuously stirred at the rotational speed of 300-500 rpm by using the magnetic stirrer or the mechanical stirrer. During the process of adding the sodium hydroxide solution to adjust the pH to 11-13, stirring is continued for 30-60 min to ensure uniform pH throughout the solution and fully contact and reaction between the fly ash and aluminum chloride.

The ball milling refers to a process that achieves fine grinding, mixing, dispersion, or mechanochemical reaction via impact, friction, and shear forces between grinding media (such as grinding balls) inside the ball mill jar and the material to be treated.

The ball mill jar refers to a container used for performing ball milling operations. The ball mill jar is typically made of wear-resistant material and contains grinding media (e.g., the grinding balls) inside the ball mill jar.

The temperature-controlled ball milling refers to a process of grinding and reacting material through mechanical impact and shear forces at a specific temperature. The temperature-controlled ball milling combines mechanochemical process and temperature control, which can promote a solid-phase reaction, crystal structure transformation, or formation of the composite material. In S2, the temperature control ensures stable synthesis and crystal growth of the LDHs. In some embodiments, the temperature may be controlled by a heating or cooling device external to the ball mill jar, for example, a circulating water bath or an electric heating mantle.
In S2, by controlling a rotational speed of the ball mill jar (700-900 rpm) and a ball-milling time (4-6 h), a particle size distribution of the generated fly ash-based LDH (CaAl—Cl-LDH) reaches a micro-nano scale, and a particle size range is controlled to be D50=1-10 μm, for example, 2 μm, 4 μm, 5 μm, 6 μm, 8 μm, and 10 μm.

In some embodiments, in S2, the rotational speed of the ball mill jar may be adjusted within a range of 700 rpm-900 rpm. In some embodiments, in S2, the rotational speed of the ball mill jar may be 700-750 rpm, 750-800 rpm, 800-850 rpm, or 850-900 rpm. For example, in S2, the rotational speed of the ball mill jar may be 700 rpm, 750 rpm, 800 rpm, 850 rpm, or 900 rpm, or any value between these values. In some embodiments, the rotational speed of the ball mill jar may also be other rotational speeds that can effectively promote the reaction and formation of the fly ash-based LDH.

The ball-to-material ratio refers to a mass ratio or a volume ratio between the grinding media (e.g., the grinding balls) and the material to be milled during the ball milling process. For example, when the ball-to-material ratio is 10:1, it means that a mass of the grinding media in the ball mill jar is 10 times that of the material to be milled.

In some embodiments, in S2, the ball-to-material ratio of the ball mill jar is controlled within a range of (4-7):1. In some embodiments, in S2, the ball-to-material ratio may be (4-5):1, (5-6):1, (6-7):1, etc. For example, in S2, the ball-to-material ratio may be 4:1, 5:1, 6:1, 6.5:1, 7:1, etc.

In some embodiments, in S2, the ball-milling temperature may be controlled within a range of 100° C.-120° C. In some embodiments, in S2, the ball-milling temperature may be 100-105° C., 105-110° C., 110-115° C., or 115-120° C. For example, the ball-milling temperature may be 100° C., 105° C., 110° C., 115° C., or 120° C., or any value between these values. In some embodiments, the ball-milling temperature may also be other temperatures that can effectively promote the reaction and formation of the fly ash-based LDH.

In some embodiments, in S2, the ball-milling time may be controlled within a range of 4-6 h. In some embodiments, in S2, the ball-milling time may be 4-4.5 h, 4.5-5 h, 5-5.5 h, or 5.5-6 h. For example, the ball-milling time may be 4 h, 4.5 h, 5 h, 5.5 h, or 6 h, or any value between these values. In some embodiments, in S2, the ball-milling time may also be other times that can effectively promote the reaction and formation of the fly ash-based LDH.

In some embodiments, in S2, the rotational speed of the ball mill jar is 900 rpm, the ball-milling temperature is 110° C., and the ball-milling time is 6 h.

By adopting the rotational speed of the ball mill jar of 900 rpm, the ball-milling temperature of 110° C., and the ball-milling time of 6 h in S2, the reaction condition and kinetics of components in the mixture can be optimized, thereby promoting effective formation of the fly ash-based LDH.
In S3, adding ammonium tetrathiomolybdate into the fly ash-based LDH obtained in S2, a mass ratio of the fly ash-based LDH to the ammonium tetrathiomolybdate being (1.1-1.5):1, adding the deionized water, and performing the temperature-controlled ball milling to obtain a mixed solution. The conditions for the temperature-controlled ball milling include a ball-to-material ratio of (8-10):1, a ball-milling time of 6-8 h, a rotation speed of 400-500 rpm, and a ball-milling temperature controlled at 80-100° C.

In some embodiments, in S3, the liquid-to-solid ratio of the deionized water to the mixture of the fly ash-based layered double hydroxide and ammonium tetrathiomolybdate may be (8-12) mL:1 g.

In some embodiments, the deionized water may be added to the mixture of the fly ash-based LDH and the ammonium tetrathiomolybdate according to the liquid-to-solid ratio of (8-12) ml:1 g. For example, the liquid-to-solid ratio of the deionized water to the mixture may be 8 mL:1 g. As another example, the liquid-to-solid ratio may be 12 mL:1 g. In some embodiments, the liquid-to-solid ratio may be (8-9) mL:1 g, (9-10) mL:1 g, (9.5-10.5) mL:1 g, (10-11) mL:1 g, or (11-12) mL:1 g.

Setting the liquid-to-solid ratio within a range of (8-12) mL:1 g can ensure that the mixture achieves good dispersibility during the temperature-controlled ball milling, which is beneficial for full contact between the fly ash-based LDH and the ammonium tetrathiomolybdate and promotes effective substitution of the interlayer chloride ions (Cl⁻) by tetrathiomolybdate ions (MoS₄²⁻). The liquid-to-solid ratio can provide suitable reaction conditions to achieve more efficient molybdenum sulfide intercalation modification. Meanwhile, the liquid-to-solid ratio also helps stabilize molybdenum elements in mechanochemical process, reducing a risk of molybdenum leaching, thereby reducing potential environmental hazards caused by the material during use.

In some embodiments, in S3, the ball-to-material ratio may be set to 8:1, 9:1, 11:1, or 12:1. In some embodiments, the ball-to-material ratio may be set to (8-8.5):1, (8.5-9):1, (9-10):1, (10-11):1, or (11-12):1. For example, the ball-to-material ratio may be selected within a range of (8:1)-(12:1), for example, 9.5:1 or 10.5:1.

In some embodiments, in S3, the rotational speed may also be set to 380 rpm, 420 rpm, 450 rpm, 480 rpm, or 500 rpm. In some embodiments, the rotational speed may also be set to 380-400 rpm, 400-420 rpm, 420-450 rpm, 450-480 rpm, or 480-500 rpm. The rotational speed may be adjusted within a range of 350-550 rpm, for example, 390 rpm or 410 rpm.

In some embodiments, in S3, the ball-milling time may also be set to 5-6 h, 6-6.5 h, 6.5-7 h, 7-7.5 h, or 7.5-8 h. In some embodiments, in S3, the ball-milling time may also be set to 5 h, 7 h, or 8 h. Merely by way of example, the ball-milling time may be adjusted within a range of 4-10 h, for example, 5.5 h or 6.5 h.

In some embodiments, in S3, the ball-milling temperature may also be set to 75° C., 85° C., 90° C., 95° C., or 100° C. In some embodiments, in S3, the ball-milling temperature may also be set to 70-75° C., 75-80° C., 80-85° C., 85-90° C., 90-95° C., or 95-100° C. Merely by way of example, the ball-milling temperature may be controlled within a range of 70-110° C., for example, 78° C. or 82° C.

In some embodiments, a particle size of the final product particle after milling in S3 remains at a micro-nano scale, and D50 is controlled within a range of 1-5 μm.

In some embodiments, in S3, the ball-to-material ratio is 10:1, the rotational speed is set to 400 rpm, the ball-milling time is 6 h, and the ball-milling temperature is 80° C.

By adopting the specific conditions of the ball milling in S3, namely, the ball-to-material ratio of 10:1, the rotational speed set to 400 rpm, the ball-milling time set to 6 h, and the ball-milling temperature set to 80° C., the mechanochemical reaction between the fly ash-based LDH and the ammonium tetrathiomolybdate can be effectively promoted. These optimized parameters can provide suitable mechanical energy input to accelerate a substitution process of interlayer chloride ions (Cl⁻) by tetrathiomolybdate ions (MoS₄²⁻), thereby achieving effective intercalation modification of molybdenum sulfide. The optimized parameters can effectively reduce leaching of Mo elements, thereby reducing potential hazards caused by the material during use. In addition, the optimized parameters also help reduce production costs, energy consumption, and environmental pollution.
In S4, performing centrifugation, filtration, washing, and drying on the mixed solution obtained in S3 to obtain a molybdenum sulfide intercalation-modified fly ash-based LDH.

The mixed solution in S3 refers to a slurry-like reaction system existing in the ball mill jar after the mechanochemical treatment is completed. The mixed solution is formed by deep reaction of the micro-nano-scale fly ash-based LDH (CaAl—Cl-LDH) prepared in S2, solid ammonium tetrathiomolybdate, and the deionized water under the temperature-controlled ball milling.

The centrifugation refers to a process of separating intercalation-modified solid particles from the liquid phase in the mixed solution obtained in S3 by using a high centrifugal force generated by a centrifuge. By adjusting a rotational speed and a time of the centrifugation, modified LDH particles at a micro-nano scale can be effectively recovered, and a majority of the unreacted solutes can be removed.
In S4, the rotational speed of the centrifugation is 5000-8000 rpm, and the time of the centrifugation is 5-15 min. Merely by way of example, in example 1, the mixed solution obtained in S3 is placed in a centrifuge tube, and the rotational speed of the centrifugation is set to 5500 rpm for separation. At the rotational speed, because modified CaAl—MoS₄-LDH particles have a certain density and micro-nano scale particle size, the modified CaAl—MoS₄-LDH particles can rapidly settle to a bottom of the tube to form a compact solid cake, thereby achieving efficient solid-liquid separation.
In S4, the filtration may be the vacuum filtration, which is used for performing solid-liquid separation on the centrifuged mixed solution. In some embodiments, the pore size of the filter membrane for the filtration is 0.22-0.45 μm. For example, the bottom solid cake after the centrifugation is taken out, or the centrifuged mixed solution is directly subjected to the vacuum filtration. Merely by way of example, a nylon filter membrane with the pore size of 0.45 μm is selected for the vacuum filtration, which can ensure that modified LDH crystals at the micro-nano scale are completely retained on a surface of the filter membrane. The filter cake obtained at this time has a loose structure, which is beneficial for a plurality of washings using the deionized water and ethanol to remove residual chloride ions or ammonium ions.

In some embodiments, in S4, the process of the washing includes washing with water twice and washing with ethanol once.

Water washing refers to cleaning a solid product using the deionized water as a washing agent. In some embodiments, the water washing can effectively remove water-soluble impurities, unreacted inorganic salts, or other water-soluble by-products. The water washing is usually performed by mixing the solid with the deionized water, fully stirring the mixture, performing the solid-liquid separation (e.g., centrifugation, filtration, or decantation), and then repeating the operations to ensure the washing effect. Water washing twice herein means that the operations are repeated twice to more thoroughly remove the water-soluble impurities, ensuring efficiency of subsequent ethanol washing and purity of the final product.

Ethanol washing refers to cleaning a solid product using ethanol as a washing agent. The ethanol washing can effectively remove organic impurities or non-polar substances that are difficult to remove by the water washing. Meanwhile, the ethanol washing also helps the product to dry quickly, avoiding effects of residual moisture on subsequent operations or stability of the product. The ethanol washing is performed by mixing the solid with ethanol, fully stirring the mixture, and performing solid-liquid separation.

In some embodiments, the process of the washing in S4 specifically includes washing with water twice first and then washing with ethanol once. The combined washing can take into account the removal of both the water-soluble impurities and the organic or non-polar impurities. The first water washing can remove a majority of the water-soluble impurities, and the second water washing further ensures thorough removal of the water-soluble impurities. The subsequent ethanol washing can then remove a small amount of possible organic impurities and accelerate drying of the product. In some embodiments, the washing operation may be implemented using various solid-liquid separation techniques such as centrifugation, filtration, or decantation.

In some embodiments, the washing process may also be performed in other ways. For example, the number of the water washing and the ethanol washing may be adjusted according to properties of specific impurities, features of the product, and required purity. As another example, in addition to water and ethanol, other suitable solvents or solvent combinations may also be used for washing to achieve the purification effect.

The washing process including washing with water twice and washing with ethanol once can effectively remove soluble impurities, unreacted substances, and by-products generated during the synthesis process, thereby significantly improving the purity of the molybdenum sulfide intercalation-modified fly ash-based LDH. Through thorough washing, interference of impurities on subsequent adsorption performance can be avoided, ensuring that the product has more excellent heavy metal adsorption capacity and selectivity. In addition, the ethanol washing helps to remove moisture, promotes rapid drying of the product, improves stability of the material, and helps reduce the risk of the Mo leaching during the adsorption application, thereby reducing potential hazards of the material and enhancing its environmental friendliness.

In some embodiments, in S4, the drying is performed at 80-105° C. in a nitrogen atmosphere.

The nitrogen atmosphere refers to an environment where pure nitrogen (N₂) was used as a surrounding environmental gas during the chemical reaction or the physical treatment (e.g., drying). The nitrogen can effectively exclude oxygen and water vapor in air, thereby preventing adverse reactions such as oxidation, decomposition, or moisture absorption of the material during high-temperature or long-term treatment, which helps maintain chemical stability and purity of the product.

In some embodiments, the drying may be performed in an oven or a vacuum drying oven equipped with a temperature control device and a nitrogen introduction device. For example, a sample of the molybdenum sulfide intercalation-modified fly ash-based LDH to be dried may be placed in a drying device, and then the nitrogen is introduced into the drying device to form an inert environment.

In some embodiments, the drying temperature inside the drying device is controlled within a range of 80-105° C. by a heating device. For example, the drying temperature may be set to any one of 80° C., 85° C., 90° C., 95° C., 100° C., or 105° C. As another example, the drying may be performed within the temperature range of 80-85° C., 85-90° C., 90-95° C., 95-100° C., or 100-105° C. In some embodiments, a drying time may be adjusted according to specific situations and a required degree of drying.

In some embodiments, the drying may also be performed in an atmosphere of other inert gases (e.g., argon (Ar)), or by vacuum drying combined with pressure reduction, so as to achieve effective drying at a relatively low temperature.

In some embodiments, in S4, the drying is performed at 100° C. in the nitrogen atmosphere for 12 h.

In some embodiments, the sample of the molybdenum sulfide intercalation-modified fly ash-based LDH to be dried may be placed in the drying device, nitrogen is introduced to form the inert environment, the temperature is precisely controlled at 100° C., and drying is continued for 12 h. For example, in example 1, the stable molybdenum sulfide intercalation-modified fly ash-based LDH is obtained by drying the material at 100° C. in the nitrogen atmosphere for 12 h.

In some embodiments, to achieve the similar effect, the drying temperature may be slightly adjusted (e.g., 95° C. or 105° C.), and the drying time may also be appropriately extended or shortened according to actual needs (e.g., drying for 10 h or 14 h)

The temperature of 100° C. can effectively remove moisture from the interior and the surface of the material, and the drying time of 12 h ensures sufficient drying depth, so that the finally obtained molybdenum sulfide intercalation-modified fly ash-based LDH has a very low water content and good storage stability. Introduction of the nitrogen atmosphere further ensures that the material does not undergo oxidation during the drying process, especially for the molybdenum-intercalated modified LDH, decomposition or oxidation of tetrathiomolybdate anions can be effectively prevented, thereby maintaining its excellent heavy metal adsorption capacity and selective adsorption characteristics. Adsorption results of Example 1 show that the material prepared under such precisely controlled drying condition has a significant adsorption capacity and good selectivity for the heavy metals.

By performing the drying in the nitrogen atmosphere, the oxidation reaction of the product with oxygen in air during high temperature treatment can be effectively avoided, thereby improving the purity and stability of the final product. For example, the molybdenum sulfide intercalation-modified fly ash-based LDH is less likely to undergo oxidation of the Mo elements or volatilization of the sulfur elements during the drying process, thereby ensuring structural integrity and performance of the material. In addition, controlling the drying temperature within the range of 80-105° C. can effectively remove residual moisture in the material while avoiding possible structural damage or performance degradation of the material caused by excessively high temperature, which helps to obtain the final product with good adsorption performance.

In some embodiments, the molybdenum sulfide intercalation-modified fly ash-based LDH is provided. The molybdenum sulfide intercalation-modified fly ash-based LDH is prepared by the method described in some embodiments of the present disclosure.

As a composite material, the molybdenum sulfide intercalation-modified fly ash-based LDH can significantly improve the adsorption capacity for the heavy metal ions in wastewater and enhance a capture capability for the heavy metal ions. The molybdenum sulfide intercalation-modified fly ash-based LDH has adsorption selectivity for the heavy metal ions, which enables the molybdenum sulfide intercalation-modified fly ash-based LDH to separate and remove a target heavy metal from complex water bodies more effectively. The molybdenum sulfide intercalation-modified fly ash-based LDH prepared by the mechanochemical process can combine Mo elements more stably in the layered structure of the material, thereby reducing the risk of Mo leaching during use. This reduces the potential hazard of the material, making the molybdenum sulfide intercalation-modified fly ash-based LDH safer and more environmentally friendly in practical applications. In addition, the mechanochemical process has advantages such as low energy consumption and short reaction time, further reducing the preparation cost and the environmental impact of the material.

Some embodiments of the present disclosure have the following beneficial effects:
(1) In some embodiments of the present disclosure, the effective components in the fly ash are utilized to synthesize the fly ash-based LDHs for absorbing the heavy metal ions in the wastewater, achieving the purpose of treating waste with waste.
(2) In some embodiments of the present disclosure, structural optimization is performed on LDHs prepared from the fly ash, the temperature-controlled ball milling process is employed to generate LDHs with interlayer Cl⁻, and then the temperature-controlled ball milling process is used to accelerate the spontaneous substitution of interlayer Cl⁻ by MoS₄²⁻, realizing the intercalation of MoS₄²⁻ between LDH layers. This not only enhances the heavy metal adsorption capacity of the fly ash-based LDHs, but also endows the material with adsorption selectivity for the specific heavy metal cation, which can meet the need for adsorption of a single heavy metal in a specific situation.
(3) In some embodiments of the present disclosure, the mechanochemical process is adopted to reduce energy consumption and shorten reaction time while improving adsorption performance of the material. The material prepared using the mechanochemical process is not prone to Mo leaching during use, thereby reducing inherent hazard of the material itself.

The method for preparing fly ash-based LDHs modified by molybdenum sulfide intercalation includes the following operations S01-S04:
In S01, washing fly ash from municipal solid waste incineration 1 to 2 times by adding the fly ash into the sodium hydroxide solution with the concentration of 0.5-1 mol/L, the liquid-to-solid ratio of the sodium hydroxide solution to the fly ash being (10-12) mL:1 g, taking the solids after fully shaking for 6-8 h, standing for 22-24 h, and filtering, to obtain the washed fly ash solids.
In S02, mixing the washed fly ash solids, deionized water, the hydrochloric acid solution with the concentration of 1-1.2 mol/L, and aluminum chloride, the mass ratio of the washed fly ash solids to the aluminum chloride being (5-20):1, and the deionized water being added according to the liquid-to-solid ratio of (10-14) mL:1 g; adjusting the pH to 11-13 by using sodium hydroxide, fully stirring to obtain the mixture, transferring the mixture into the ball mill jar, controlling the temperature at 100-120° C., and performing ball milling, the rotational speed of the ball mill jar being 700-900 rpm, the ball-to-material ratio being (4-7):1, and the ball-milling time being 4-6 h; and performing centrifugation, water washing, and drying on the solid-liquid mixture obtained after the ball milling to obtain the fly ash-based LDH, designated as CaAl—Cl-LDH.
In S03, adding ammonium tetrathiomolybdate into the fly ash-based LDH obtained in S2, the mass ratio of the fly ash-based LDH to the ammonium tetrathiomolybdate being (1.1-1.5):1, adding the deionized water according to the liquid-to-solid ratio of (8-12) mL:1 g, and performing the temperature-controlled ball milling at 80-100° C. The conditions for the temperature-controlled ball milling include the ball-to-material ratio of (8-10):1, the ball-milling time of 6-8 h, and the rotation speed of 400-500 rpm.
In S04, performing centrifugation, filtration, washing twice with water on the mixed solution in S3, followed by drying at 80-105° C. in the nitrogen atmosphere to obtain the molybdenum sulfide intercalation-modified fly ash-based LDH, designated as CaAl—MoS₄-LDH.

The present disclosure also provides the molybdenum sulfide intercalation-modified fly ash-based LDH prepared using the above method.

The present disclosure further provides a use of the molybdenum sulfide intercalation-modified fly ash-based LDH prepared by the above method in the heavy metal adsorption in the wastewater.

The present disclosure further provides a use of the molybdenum sulfide intercalation-modified fly ash-based LDH prepared by the above method in the selective adsorption of the heavy metals in the wastewater.

In some embodiments, the heavy metal for the selective adsorption includes Ag, Hg, Cu, and Pb. In some embodiments, the heavy metal for the selective adsorption is preferably Ag, followed by Hg.

### Example 1

The method for preparing fly ash-based LDHs modified by molybdenum sulfide intercalation includes the following operations:
In S11, adding the fly ash from municipal solid waste incineration into the sodium hydroxide solution with a concentration of 1 mol/L, the liquid-to-solid ratio of the sodium hydroxide solution to the fly ash being 10 mL:1 g, stirring for 6 h, and standing for 24 h; performing vacuum filtration on the obtained mixture by using the filter membrane of 0.45 μm, and taking the solids.
In S12, weighing the solids obtained in S11 and aluminum chloride at the mass ratio of 10:1, adding the hydrochloric acid solution with a concentration of 1 mol/L at the liquid-to-solid ratio of 3 mL:1 g, mixing uniformly, supplementing deionized water at the liquid-to-solid ratio of 10 mL:1 g, adjusting the pH to 12 with the sodium hydroxide solution with a concentration of 2 mol/L to obtain a mixture, transferring the mixture into the ball mill jar, setting the rotational speed at 900 rpm, controlling the temperature at 110° C., and performing ball milling for 6 h; performing centrifugation and water washing on the resulting mixture, and drying at 105° C. for 24 h to obtain the fly ash-based LDH, designated as CaAl—Cl-LDH.
In S13, adding the obtained fly ash-based LDH and the ammonium tetrathiomolybdate into the ball mill jar at the mass ratio of 1.2:1, adding the deionized water at the liquid-to-solid ratio of 8 mL:1 g, and performing the mechanochemical treatment under conditions including the ball-to-material ratio of 10:1, the rotational speed of the ball mill jar of 400 rpm, the ball-milling time of 6 h, and the ball-milling temperature of 80° C.
In S14, separating a solid phase at the centrifugation speed of 5500 rpm, washing twice with the deionized water and once with ethanol, and the drying at 100° C. in the nitrogen atmosphere for 12 h to obtain the molybdenum sulfide intercalation-modified fly ash-based LDH.

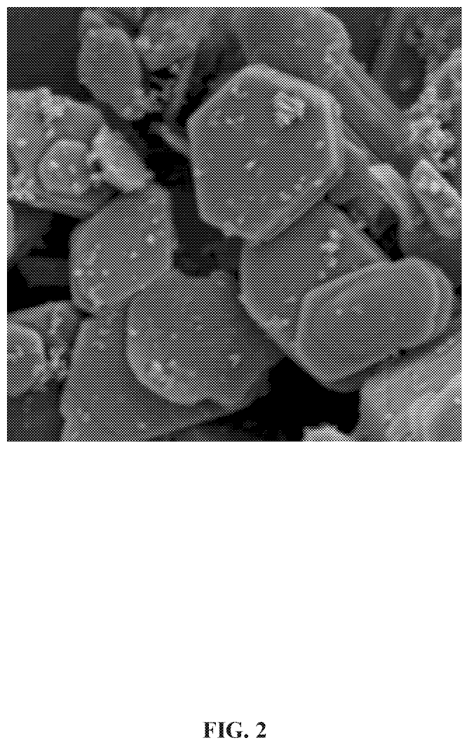

FIG. 2 is a scanning electron microscope (SEM) image of the LDHs obtained in Example 1 of the present disclosure. As shown in FIG. 2, the prepared material exhibits a typical layered sheet-like structure, and the lamellar edges and surface morphology are favorable for contact and diffusion of metal ions in the aqueous phase. The high-resolution electron microscopy image indicates that the interlayer structure is changed, which is consistent with the expectation of MoS₄²⁻ intercalation modification, thereby providing a microscopic basis for the enhanced adsorption and improved selectivity toward Ag⁺ observed in the subsequent adsorption experiment.

### Example 2

The preparation method includes operations identical to those in Example 1, with the difference that in S12, the pH was adjusted to 13 with 2 mol/L sodium hydroxide solution.

### Example 3

The preparation method includes operations identical to those in Example 1, with the difference that in S12, the mass ratio of the fly ash to the aluminum chloride was set to 15:1.

### Example 4

The preparation method includes operations identical to those in Example 1, with the difference that in S12, the mass ratio of the fly ash to the aluminum chloride was set to 20:1.

### Example 5

The preparation method includes operations identical to those in Example 1, with the difference that in S12, the rotational speed of the ball mill jar was set to 800 rpm.

### Example 6

The preparation method includes operations identical to those in Example 1, with the difference that in S13, the rotational speed of the ball mill jar was set to 500 rpm.

### Example 7

The preparation method includes operations identical to those in Example 1, with the difference that in S12, the ball-milling time was set to 4 h.

### Example 8

The preparation method includes operations identical to those in Example 1, with the difference that in S13, the ball-milling time was set to 8 h.

### Example 9

The preparation method includes operations identical to those in Example 1, with the difference that in S12, the liquid-to-solid ratio was 12 mL:1 g.

### Example 10

The preparation method includes operations identical to those in Example 1, with the difference that in S13, the liquid-to-solid ratio was 10 mL:1 g.

### Comparative Example 1

The preparation method includes operations identical to those in Example 1, with the difference that in S12, the pH was adjusted to 10 with 2 mol/L sodium hydroxide solution.

### Comparative Example 2

The preparation method includes operations identical to those in Example 1, with the difference that in S12, the mass ratio of the fly ash to the aluminum chloride was set to 25:1.

### Comparative Example 3

The preparation method includes operations identical to those in Example 1, with the difference that in S12, the rotational speed of the ball mill jar was set to 500 rpm.

### Comparative Example 4

The preparation method includes operations identical to those in Example 1, with the difference that in S13, the ball-to-material ratio was 10:1.

### Comparative Example 5

The preparation method includes operations identical to those in Example 1, with the difference that in S13, the rotational speed of the ball mill jar was set to 900 rpm.

### Comparative Example 6

The preparation method includes operations identical to those in Example 1, with the difference that in S12, the ball-milling time was set to 2 h.

### Comparative Example 7

The preparation method includes operations identical to those in Example 1, with the difference that in S12, the ball-milling temperature was set to 80° C.

### Comparative Example 8

The preparation method includes operations identical to those in Example 1, with the difference that in S13, the ball-milling temperature was set to 120° C.

### Comparative Example 9

The preparation method includes operations identical to those in Example 1, with the difference that in S13, the liquid-to-solid ratio was 5 mL:1 g.

### Comparative Example 10

The preparation method includes operations identical to those in Example 1, with the difference that in S13, the mass ratio of the fly ash-based LDH to the ammonium tetrathiomolybdate was 2:1.

Adsorption experiments were performed using the molybdenum sulfide intercalation-modified fly ash-based LDHs prepared in Examples 1-10 and Comparative Examples 1-10, with the procedure as follows:
(1) 0.05 g of the above-prepared molybdenum sulfide intercalation-modified fly ash-based LDH materials was mixed with 100 mL of simulated solution, respectively; the initial concentrations of silver nitrate, mercury nitrate, lead nitrate, and copper nitrate in the four simulated solutions were all 500 mg/L; the mixture was shaken and stirred at 400 rpm for 6 h at 25° C., and centrifuged at 7000 rpm for 5 min to obtain a supernatant and a solid residue; the supernatant was filtered through a filter membrane of 0.22 μm; and concentrations of heavy metal ions in the liquid phase before and after adsorption were determined by Inductively Coupled Plasma Optical Emission Spectrometry (ICP-OES).

Adsorption results of the materials prepared in Examples and Comparative Examples are shown in Table 1.

TABLE 1
Heavy metal adsorption results of materials prepared
in Examples 1-10 and Comparative Examples 1-10

| | Adsorption Capacity | | | |
|---|---|---|---|---|
| Preparation protocol | Ag mg/g | Hg mg/g | Cu mg/g | Pb mg/g |
| Example 1 | 912 | 684 | 502 | 406 |
| Example 2 | 711 | 596 | 368 | 278 |
| Example 3 | 832 | 690 | 483 | 416 |
| Example 4 | 844 | 712 | 316 | 356 |
| Example 5 | 740 | 614 | 346 | 291 |
| Example 6 | 777 | 644 | 363 | 273 |
| Example 7 | 728 | 602 | 336 | 327 |
| Example 8 | 783 | 664 | 436 | 217 |
| Example 9 | 748 | 622 | 395 | 222 |
| Example 10 | 766 | 650 | 422 | 302 |
| Comparative Example 1 | 285 | 181 | 101 | 87 |
| Comparative Example 2 | 415 | 273 | 213 | 149 |
| Comparative Example 3 | 444 | 312 | 164 | 107 |
| Comparative Example 4 | 290 | 364 | 243 | 84 |
| Comparative Example 5 | 277 | 143 | 229 | 176 |
| Comparative Example 6 | 428 | 305 | 216 | 124 |
| Comparative Example 7 | 582 | 464 | 383 | 269 |
| Comparative Example 8 | 153 | 87 | 65 | 42 |
| Comparative Example 9 | 566 | 350 | 270 | 254 |
| Comparative Example 10 | 502 | 477 | 398 | 251 |

The results show that the prepared products by the preparation method under appropriate conditions exhibit significantly higher adsorption capacities for Ag, Hg, Cu, and Pb than those of the products prepared in Comparative Examples 1-10. Inappropriate conditions affect the synthesis and structural optimization of the LDHs in S12, which leads to the failure of substitution of interlayer Cl⁻ by MoS₄²⁻ and intercalation of MoS₄²⁻ between LDH layers in S13, thereby greatly affecting the heavy metal adsorption capacity of the fly ash-based LDHs.

The data in Table 1 show that the molybdenum sulfide intercalation-modified fly ash-based LDHs prepared Examples 1-10 exhibit far superior heavy metal adsorption performance than those of the Comparative Examples. In particular, the product prepared in Example 1 achieves an Ag⁺ adsorption capacity as high as 912 mg/g and an Hg²⁺ adsorption capacity of 684 mg/g. When inappropriate process parameters (e.g., the pH, the mass ratio, or the ball-milling conditions) result in failed intercalation (Comparative Examples 1-10), the adsorption capacity drops precipitously (e.g., only 153 mg/g for Ag⁺ in Comparative Example 8). This demonstrates that the preparation conditions specified in the examples are critical for successful substitution of interlayer Cl⁻ by MoS₄²⁻ and the enhancement of adsorption performance.

Adsorption performance tests were performed on the products obtained after S12 and the final products in examples. The results are shown in Table 2.

TABLE 2
Adsorption performance of the fly ash-based LDHs
before and after MoS₄²⁻ intercalation modification

| Fly Ash- | Adsorption Capacity | | | |
|---|---|---|---|---|
| Based LDH | Ag (mg/g) | Hg (mg/g) | Cu (mg/g) | Pb (mg/g) |
| After | 912 | 684 | 502 | 406 |
| modification | | | | |
| Before | 462 | 433 | 422 | 202 |
| modification | | | | |

The results show that after MoS₄²⁻ intercalation modification, the heavy metal adsorption capacity of the fly ash-based LDHs is markedly enhanced, with the most pronounced improvement observed for silver ions.
(2) 0.05 g of the molybdenum sulfide intercalation-modified fly ash-based LDH material prepared in Example 1 was mixed with 100 mL of a simulated solution. The initial concentrations of silver nitrate, mercury nitrate, lead nitrate, and copper nitrate in the simulated solution were all 500 mg/L. The mixture was shaken and stirred at 400 rpm at room temperature (25° C.) for 6 h, and then centrifuged at 7000 rpm for 5 min to obtain a supernatant and a solid residue. The supernatant was filtered through a filter membrane of 0.22 μm, and the concentrations of the heavy metal ions in the liquid phase before and after adsorption were determined by ICP-OES. The results are shown in Table 3.

TABLE 3
Adsorption performance of the molybdenum sulfide intercalation-
modified fly ash-based LDH prepared in Example 1
Adsorption Capacity

| Ag (mg/g) | Hg (mg/g) | Cu (mg/g) | Pb (mg/g) |
|---|---|---|---|
| 792 | 288 | 102 | 47 |

The results show that after MoS₄²⁻ intercalation modification, the fly ash-based LDHs exhibit adsorption selectivity for the heavy metals, with the selectivity order being

$${Ag}^{+} > {Hg}^{2 +} > {Cu}^{2 +} > {Pb}^{2 +} .$$

(3) 0.1 g of the molybdenum sulfide intercalation-modified fly ash-based LDH material prepared in Example 1 and the LDHs before ball milling in S13 of Example 1 were placed in 100 mL of water, respectively. The mixture was shaken and stirred at 400 rpm at the room temperature (25° C.) for 6 h, followed by vacuum filtration through the filter membrane of 0.45 μm, and the leaching amount of Mo elements was analyzed using ion chromatography. The results are shown in Table 4.

TABLE 4
Comparison of leaching amount of Mo elements
from LDHs before and after ball milling

| Material | Mo Leaching Amount (mg/g) |
|---|---|
| LDHs after ball milling | 12.23 |
| LDHs before ball milling | 23.69 |

The results show that the Mo leaching amount in the LDHs before the ball milling is 1.94 times that in the LDHs after the ball milling. The Mo leaching amount in the modified LDHs material obtained after the ball milling in S13 is reduced by nearly half compared to that in the material before the ball milling. The Mo elements in the modified LDHs material obtained after the ball milling in S13 are more stable, which are less prone to leaching, thus reducing the hazard of the material itself.

All documents mentioned in the present disclosure are incorporated herein by reference, as if each document is individually incorporated by reference. In addition, it should be understood that, after reading the above teachings of the present disclosure, those skilled in art can make a plurality of changes or modifications to the present disclosure. These equivalent forms also fall within the scope defined by the present disclosure.

What is claimed is:

1. A method for preparing fly ash-based layered double hydroxides modified by molybdenum sulfide intercalation, comprising:
S1, washing fly ash from municipal solid waste incineration 1 to 2 times by adding the fly ash into a sodium hydroxide solution, wherein a liquid-to-solid ratio of the sodium hydroxide solution to the fly ash is (10-12) mL:1 g; and taking solids after filtration to obtain washed fly ash solids;
S2, mixing the washed fly ash solids, deionized water, a hydrochloric acid solution, and aluminum chloride, wherein a mass ratio of the washed fly ash solids to the aluminum chloride is (5-20):1, and the deionized water is added according to a liquid-to-solid ratio of (10-14) mL:1 g;
adjusting a pH to 11-13 by using sodium hydroxide, fully stirring to obtain a mixture, transferring the mixture into a ball mill jar for temperature-controlled ball milling, and performing centrifugation, water washing, and drying on a solid-liquid mixture obtained after the ball milling to obtain the fly ash-based layered double hydroxide;
S3, adding ammonium tetrathiomolybdate into the fly ash-based layered double hydroxide obtained in S2, wherein a mass ratio of the fly ash-based layered double hydroxide to the ammonium tetrathiomolybdate is (1.1-1.5):1, adding the deionized water, and performing the temperature-controlled ball milling to obtain a mixed solution; and
S4, performing centrifugation, filtration, washing, and drying on the mixed solution obtained in S3 to obtain a molybdenum sulfide intercalation-modified fly ash-based layered double hydroxide; wherein
in S2, a rotational speed of the ball mill jar is 700-900 rpm, a ball-to-material ratio is (4-7):1, a ball-milling time is 4-6 h, and a ball-milling temperature is controlled at 100-120° C.; and
in S3, conditions for the temperature-controlled ball milling include a ball-to-material ratio of (8-10):1, a ball-milling time of 6-8 h, a rotation speed of 400-500 rpm, and a ball-milling temperature controlled at 80-100° C.

2. The method of claim 1, wherein in S1, a concentration of the sodium hydroxide solution is 0.5-1 mol/L.

3. The method of claim 1, wherein in S1, a process of the washing includes: fully shaking for 6-8 h and standing for 22-24 h.

4. The method of claim 1, wherein in S1, a process of the washing includes: stirring for 6 h and standing for 24 h.

5. The method of claim 1, wherein in S1, the filtration is vacuum filtration using a filter membrane with a pore size of 0.45 μm.

6. The method of claim 1, wherein in S2, a concentration of the hydrochloric acid solution is 1-1.2 mol/L.

7. The method of claim 1, wherein in S2, the mass ratio of the washed fly ash solids to the aluminum chloride is 10:1.

8. The method of claim 1, wherein in S2, the rotational speed of the ball mill jar is 900 rpm, the ball-milling temperature is 110° C., and the ball-milling time is 6 h.

9. The method of claim 1, wherein in S3, a liquid-to-solid ratio of the deionized water to a mixture of the fly ash-based layered double hydroxide and the ammonium tetrathiomolybdate is (8-12) mL:1 g.

10. The method of claim 1, wherein in S3, the ball-to-material ratio is 10:1, the rotational speed is 400 rpm, the ball-milling time is 6 h, and the ball-milling temperature is 80° C.

11. The method of claim 1, wherein in S4, a process of the washing includes washing with water twice and washing with ethanol once.

12. The method of claim 1, wherein in S4, the drying is performed at 80-105° C. in a nitrogen atmosphere.

13. The method of claim 1, wherein in S4, the drying is performed at 100° C. in a nitrogen atmosphere for 12 h.

14. A molybdenum sulfide intercalation-modified fly ash-based layered double hydroxide, which is prepared by using the method according to claim 1.
